(19) United States
(12) Patent Application Publication
(10) Pub. No.: US 2002/0184636 A1
(43) Pub. Date: Dec. 5, 2002

(54) Video recorder scheduling

(76) Inventor: Peter Vogel, Faulconbridge (AU)

Correspondence Address: FISH & RICHARDSON, PC, 4350 LA JOLLA VILLAGE DRIVE, SUITE 500, SAN DIEGO, CA, 92122, US

(21) Appl. No.: 10/149,926

(22) PCT Filed: Dec. 15, 2000
(86) PCT No.: PCT/AU00/01544

(30) Foreign Application Priority Data
Dec. 17, 1999 (AU) PQ 4693

(51) Int. Cl. H04N 5/445; G06F 3/00

(52) U.S. Cl. 725/51

(57) ABSTRACT

A system for controlling recording of television programs utilizing a TV guide, which is provided as a web page and used to select programs to be recorded, and realtime control signals transmitted via the Internet or other medium. Recording is started and stopped according to the content of the realtime control signals.

### FIELD OF THE INVENTION

The present invention relates to systems for creating schedules of broadcast programs and in particular to systems for presetting domestic video recorders for unattended recording of desired programs.

### BACKGROUND OF THE INVENTION

Video cassette recorders (VCRs) are commonly used in a domestic situation for recording of television programs for viewing at a later date. To enable unattended recording, most VCRs are equipped with timer means which automatically start the machine recording a preselected channel at a preselected time and date and also stops recording after a preselected time has elapsed.

Conventionally, the user must enter channel, date, time, and program length (CDTL) information into the VCRs memory to facilitate this function. This procedure is quite onerous and error-prone, and several systems have been proposed for overcoming some of these difficulties.

One such system, known as Programme Delivery Control (PDC) is a system which identifies TV programs during transmission by transmitting a label comprising the program channel, the program date, and the scheduled program start time. The label is repeated every thirty seconds while the program is being broadcast. To record a desired program, the program channel, the program date, and the scheduled program start time are entered by the user, and when the received label matches the entered label, recording starts. When the label has not been received for a certain time, or the label of the next program is received, recording stops.

PDC is effective, however if the user has to enter the program details manually, the system is inconvenient and prone to error. The system is much more convenient if used in conjunction with an on-screen TV guide, for example a teletext page representing a TV guide. In this case the PDC label can be associated with the TV guide entry of interest and automatically stored with a single command from the user. This system is a great improvement on the prior art, however it suffers some limitations. For example, unless an on-screen TV guide with the requisite PDC labels is available, the user still has to identify the program by time, channel and so on. Furthermore, implementation of PDC requires considerable effort and cooperation from broadcasters, as well as quite complex and costly equipment dedicated for this purpose at the viewer's home.

Another system for providing television schedule information and programming video recordings is described in WIPO patent publication WO 97/13368, applicant Starsight Telecast Incorporated, which is hereby incorporated by reference for all purposes. Starsight's system provides TV guide information as a database on the internet. Guide information, including starting and finishing times, dates and channels for specific programs, can be downloaded to a computer which may be internal or external to a television receiver or recorder. The computer can then use this information to start and stop recording at the scheduled times. Alternatively the timing information can be downloaded to the recorder, so that unattended recording can be achieved even when the computer is switched off or not connected to the internet. While this system does provide a convenient method of programming a video recorder by allowing the user to simply select the required programs from the web-based guide page, correct recording of programs still relies on a timer in the computer or in the video recorder to be set correctly. Furthermore last-minute schedule changes can result in incorrect recording unless the system has retrieved the updated schedule information since the change of schedule.

### SUMMARY OF THE INVENTION

It is an object of this invention to provide a system and process which allows a user to utilise a standard personal computer with internet access to schedule programs to be recorded. It is a further object of the invention to provide such a system which controls recording programs with greater accuracy than prior-art systems by using real-time control from a remote station. The present invention therefor provides control of recording that is accurate enough to ensure that the desired program is accurately recorded or viewed in spite of schedule changes and further allows editing of programs according to content classification. This system allows unwanted material such as commercial breaks or violent scenes to be accurately excised, or wanted material to be accurately included. For example this invention can be beneficially applied to a system which records only commercials, for monitoring or informational purposes.

In one embodiment, the present invention provides a program identifying system comprising an interactive server which serves television guide pages and a realtime control transmitter. In other aspects, the realtime control transmitter can be an internet server, a radio transmitter or a modulator which encodes the realtime control signals onto another carrier. For example, the realtime signals can be conveyed by a paging service, FM radio subcarrier, television VBI, cable TV service, or telephone line.

In some embodiments of the invention, the realtime control comprises signals identifying the classification of programs being broadcast on each of the available channels. In certain embodiments the classification can include the rating of the program or the genre of the program, or the classification can identify commercials breaks.

In one embodiment of the invention, a program identifying system is provided comprising a server which serves television guide pages interactively using a hypertext transfer protocol and serves realtime control signals.

In yet another embodiment, the present invention provides a program controller comprising computing means adapted to receive realtime control signals from a remote server using an internet protocol and, according to user input to said computing means, control display, audition or recording of programs. In the above embodiment, user input may be entered by selection of a program item displayed on a television schedule. Furthermore, the user input may be a selection of a program item displayed on a web page representing a television schedule received from a remote host.

In yet another embodiment, the present invention provides a program controller wherein realtime control signals include signals identifying which programs are currently being broadcast, and the controller compares said identifying signals with the user input and controls recording of programs according to the result of this comparison. In one embodiment, control of program recording is arranged so that recording starts when broadcast of a program item selected by the user commences.

In yet another embodiment, the present invention provides a program controller comprising computing means adapted to receive realtime control signals from a remote server using an internet protocol and control means adapted to control program recording means so that recording is suspended while the realtime control signals indicate that non-program material is being broadcast on a channel from which a program is being recorded.

In another embodiment, the invention provides a program recording control method comprising the steps of serving a television guide web page to the internet in response to requests from a remote site; transmitting signals identifying which programs are currently or imminently being broadcast; receiving said web page and said identifying signals; receiving user input selecting which program items described in the guide web page correspond to programs to be recorded; comparing the selected program items with the identifying signals and, according to the result of said comparison, controlling operation of recording means.

In the above method, the step of controlling operation of recording means may include the steps of starting recording if the comparison indicates that broadcast of a selected program item is beginning or in progress and stopping recording if the comparison indicates that broadcast of a selected program item is finished. The method may also include the step of tuning a program receiver to a channel according to channel information associated with a program item selected for recording.

In yet another embodiment, the program recording control method as described above may utilise program identifying signals which are transmitted through the internet. Alternatively, the program identifying signals may be transmitted by radio or by cable.

In some of the foregoing embodiments, the invention can use polling of the remote host to obtain the realtime control signals. In others, a push protocol can be used, which does not require polling and generally provides faster response.

In some embodiments, the realtime control signals are served using internet protocol multicasting. In other embodiments the realtime control signals are served using hypertext transfer protocol (HTTP) or using user datagram protocol (UDP). In case of network failure or unacceptable network delay, some embodiments of the invention are further adapted to recognise loss of user datagrams, or lack of response to a HTTP or other request, for a period exceeding a preset period to cause a default program identifier to be used. For example, the invention can be used to eliminate commercials from video recordings, UDP being used to convey the instantaneous status of either commercial or program. However as UDP is not guaranteed to reach the destination, it would be possible that the video recorder could be erroneously left in the paused state due to failure to receive a “commercial” UDP signal. Using the foregoing embodiment of the invention, however, loss of UDP datagrams for a period of greater than one second, for example, would be interpreted as the default identifier of “program”, so that recording would resume. If subsequent datagrams indicated “commercial”, recording would again be paused. If subsequent datagrams indicated “program” then recording would simply continue. In cases where the recording device can be controlled sufficiently accurately, any errors can be corrected by repositioning the recording point appropriately in the event of data loss and consequent unwanted recording of commercials.

The invention also consists in recording apparatus which includes the inventive features according to the foregoing description.

Furthermore, the invention also consists in a controller which provides the inventive features according to the foregoing description which is separate from a recording means and controls it by suitable signaling.

### DESCRIPTION OF PREFERRED EMBODIMENTS

Embodiments of the invention will now be described with reference to the drawings in which:

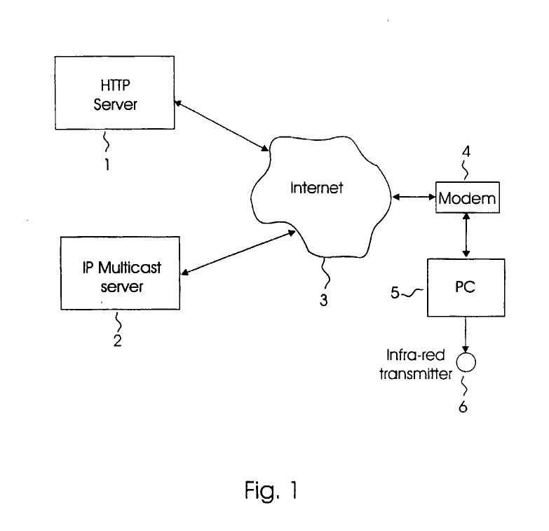

FIG. 1 is a block diagram of an embodiment of the present invention utilizing internet protocol multicast (IP multicast) for real-time control;

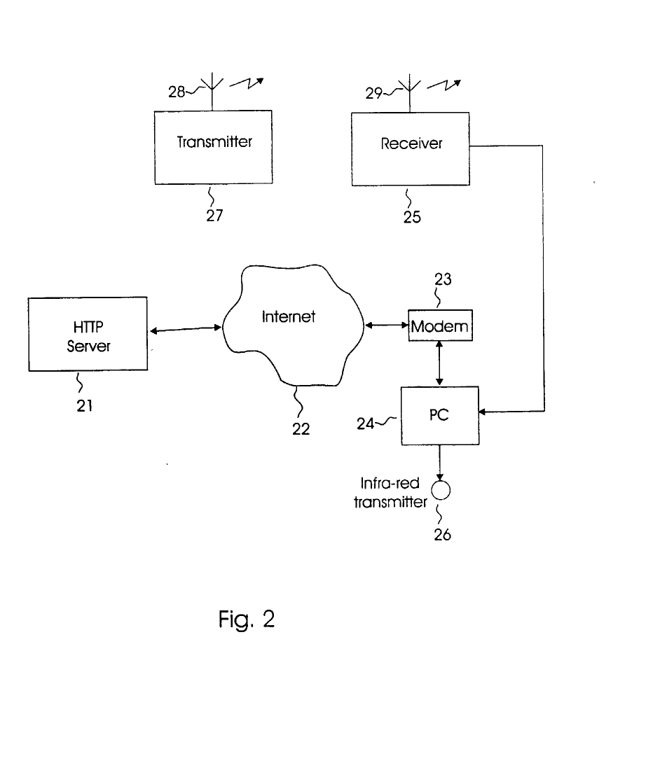

FIG. 2 is a block diagram of an embodiment of the present invention utilizing radio broadcast for real-time control;

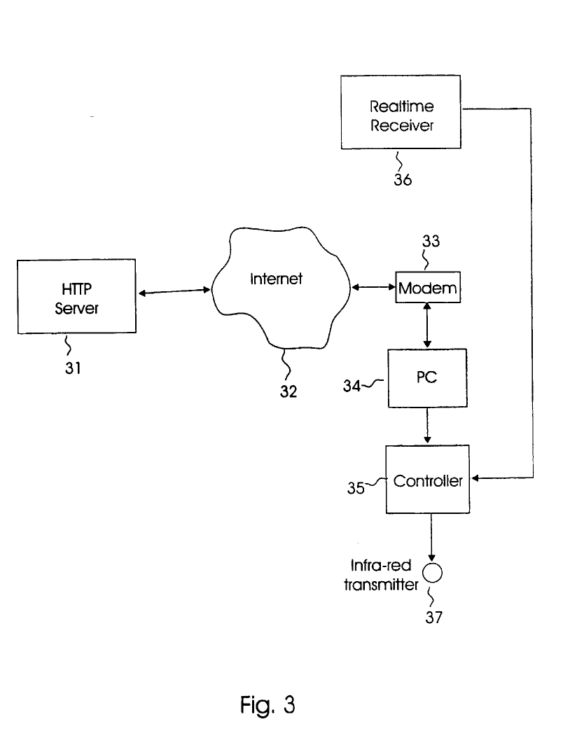

FIG. 3 is a block diagram of an embodiment of the present invention which controls the VCR even when the PC is turned off.

Referring now to FIG. 1, there is shown a block diagram of an embodiment of the invention which uses IP multicast to convey the real-time controls. HTTP server 1 is a conventional web server connected to the internet 3. One of the web pages served by this server is a TV guide comprising the familiar grid of channels and show titles as a function of airing time.

The user of the system, operating PC (personal computer) 5, browses the guide using a conventional web browser, and reviews what programs are available in coming hours or days. To record one of the programs listed on the web page, the user clicks the PC's mouse on the title of interest. This invokes a hyperlink which retrieves further details about the TV show, such as a movie review, rating and so on. The resulting frame includes a button to click to arm recording, in this exemplary embodiment an image of a red recording button on a miniature representation of a VCR. This action invokes software which takes identifying data contained invisibly in the title's detail frame and appends it to a record queue file. Other information, such as the time, date title and channel of the selected TV show are also written to the queue file. These function can conveniently be provided by means of an active-x component embedded in the guide web page, or by other well-known web software techniques.

Selecting a title for recording also causes a recording task to be launched which reads the record queue file. The recording task examines the file's contents to discover when the next queued TV show is scheduled to start.

A few minutes before the scheduled start time, the recording task opens a connection to IP multicast server 2. This server multicasts realtime control information to the internet. This information includes the current status for each TV service available in a particular geographic area. In most cases it is preferable to provide separate servers for each locale, since the information is geographically specific and distribution in this manner minimises bandwidth requirements and propagation delays.

The recording task then constantly monitors the multicast data, looking for an identifier that indicates that the program to be recorded is commencing. When such a signal is detected, the recording task then issues a “start VCR” command to IR transmitter 6. This command is typically the code sequence required by the particular VCR being controlled to cause the machine to start recording.

In this embodiment, IR transmitter 6 is connected to the PC through the standard PC serial port, and includes the required interface and driver circuitry to receive serial characters and perform the necessary translation to a modulated serial bit stream as required for infra-red remote controllers.

While recording continues, the recording task monitors the multicast data looking for changes in status on the channel being recorded. When a commercial break starts, data indicating this changed status is detected by the recording task, which in turn issues a “pause” command to the VCR via IR transmitter 6. Similarly, when the commercial break finishes, a “resume” signal, which for most VCRs is the “record” signal, is issued.

In this manner the invention can be used to eliminate ads from the recording. In this embodiment, this feature is optionally enabled by the user by selecting an appropriate checkbox on the web-page frame which was used to select recording of the program. In other embodiments, excision of advertising is available as a premium service, which is only available if the user pays a fee, after which the feature is enabled remotely.

Once the program being recorded has finished, the recording task recognises a new program identifier in the received multicast stream, and issues a VCR “stop” command via IR transmitter 6. The multicast connection is then closed by the recording task, unless another recording is scheduled to occur soon. It is of course possible that multiple programs have been selected for recording, in which case the recording task finds the next show in the queue and the process is repeated.

The realtime data used by this and other embodiments can be provided by a number of methods. One effective system is to use a number of people monitoring broadcasts as they go to air. These people then enter data into a computer as the content of a channel changes. Improved methods of performing this monitoring method are described in U.S. Pat. No. 5,371,795 to Vogel which is hereby incorporated by reference for all purposes. Other systems, such as pattern recognition schemes, can also be utilized with good results.

To allow the invention to be used to control a variety of VCR models, a web page for configuration of infra-red codes is provided by HTTP server 1. This page allows the user to select the brand and model of VCR they wish to use, and the appropriate infra-red control codes are downloaded to PC 5.

Referring now to FIG. 2, another embodiment of the invention will be described. In this embodiment, the realtime data used by the system is received via a radio receiver, rather than via the internet as in the previously-described embodiment. Operation of this embodiment is similar to the embodiment of FIG. 1 except that the realtime identifying data originates from antenna 28 fed by transmitter 27, rather than through the internet. The realtime identifying data is received by radio receiver 25 via antenna 29, and which is interfaced to PC 24.

The use of radio for broadcast of the realtime data can be advantageous in circumstances where the internet cannot deliver data quickly enough, or where multicasting is not available, for example due to routing or bandwidth limitations. Another advantage is that the PC does not need to be connected to the internet at the time of airing of the show to be recorded. That is, recording can be set up whenever the user's PC has internet access, after which control of recording is performed by the PC in response to the data received by radio receiver 25.

U.S. Pat. No. 5,371,795 discloses techniques which can be beneficially used with the present invention to allow effective use of a radio paging transmitter as transmitter 27 for broadcast of the realtime data.

In this embodiment, the recording task running on PC 24 can monitor the realtime data continuously, rather than only during times of interest, as there is no cost in terms of bandwidth associated with receiving the data.

HTTP server 21 serves the guide web pages to the internet 22. PC 24 receives the guide pages from the interact 22 via modem 23 and controls the VCR via infra-red transmitter 26.

Referring now to FIG. 3, another embodiment of the invention will be described. In this embodiment, controller 35 is provided as an interface between PC 34 and IR transmitter 37. Controller 35 includes a microcontroller and is arranged to be able to execute the recording task that is provided by the PC in the previously-described embodiments, without the need to have the PC running at the time of shows being recorded.

The realtime data used by the system is received via realtime receiver 36, which in this exemplary embodiment is a radio receiver, and fed to controller 35.

Operation of this embodiment is similar to the embodiment of FIG. 1 except that when shows are selected for recording, PC 34 sends the necessary information to controller 35, where it is stored for later reference, and controller 35 then carries out the VCR control tasks in response to realtime data provided by realtime receiver 36.

In one variant of this embodiment, realtime receiver 36 is a TCP/IP receiver connected to the internet, for example via a cable modem.

As with the previously-described embodiments, HTTP server 31 serves the guide web pages to the internet 32. PC 34 receives the guide pages from the internet 32 via modem 33. Controller 35 and controls the VCR via infra-red transmitter 37.

It will be understood that certain modifications and extensions of the inventive concept will be obvious to those skilled in the art and can be made without departing from the scope of the present invention.

For example, whereas the preferred embodiments of the invention described herein refer to use for controlling a video cassette recorder, the invention is applicable to other recording means, including, for example DVD and hard-disk based recorders. The invention can also be used to control other types of devices. For example viewing of programs on television receivers can be controlled, or audition of programs by radio receivers. The invention can also be used for controlling audio recorders.

Furthermore, although these embodiments use infra-red signaling to control the recorder, other means of control can be used with good effect. In particular, if the VCR is equipped with a suitable control interface, such as a serial port, a direct connection can be made between the controller of the invention and the VCR to be controlled. Other forms of wireless control systems can also be used with good effect.

It will be understood that while the embodiments of FIGS. 2 and 3 use a radio receiver for realtime data conveyance, a wide range of other media can be used with suitable receivers. For example, in some cases it will be convenient to use the vertical blanking interval of a television signal as a carrier for the realtime data. In other cases an FM subcarrier can be used. A telephone line or cable television cable can also be used to convey the realtime data.

Whereas the exemplary embodiments herein utilise a personal computer as the web-browsing means, it is of course possible to use other types of computer, such as an embedded microcontroller, instead.

The invention can also be incorporated into other equipment, for example built into a VCR, personal computer or television receiver.

1. A program recording scheduling system comprising:
a program guide server which serves a television program guide to the internet; and
and a program identifying transmitter which transmits realtime program identifying signals.

2. A program recording scheduling system according to claim 1 in which said program identifying transmitter is a server which serves realtime program identifying signals to the internet.

3. A program recording scheduling system according to claim 1 in which said program identifying transmitter comprises radio transmission means.

4. A program recording scheduling system according to claim 1 in which said program identifying signals are conveyed by electrical or optical cable.

5. A program recording scheduling system according to claims 1-4 in which the realtime program identifying signals include identification of programs being broadcast in prescribed geographical region.

6. A program recording scheduling system according to claims 1-4 in which the realtime program identifying signals include classification of programs being broadcast in prescribed geographical region.

7. A program recording scheduling system according to claims 1-4 in which the realtime program identifying signals are transmitted using internet protocol multicasting.

8. A program recording scheduling system according to claims 1-4 in which the realtime program identifying signals are transmitted using hypertext transfer protocol.

9. A program recording scheduling system according to claims 1-4 in which the realtime program identifying signals are transmitted using user datagram prototcol.

10. A program recording scheduling system according to claims 1-4 in which the program guide is served as at least one web page.

11. A system according to claims 1-4 and further comprising a controller adapted to control recording or viewing of a program and further adapted so that, in the event of communication with the program identifying transmitter being lost for longer than a prescribed time, recording or viewing of the program is controlled according to a pre-determined default algorithm.

12. A system according to claim 11 wherein said default algorithm dictates that if communication with the server is lost for longer than a prescribed time while viewing or recording of a program has been interrupted by said controller, recording or viewing of the program is resumed.

13. A system according to claim 11 wherein said default algorithm dictates that if communication with the program identifying transmitter is lost for longer than a prescribed time while viewing or recording a program, recording or viewing of the program is interrupted.

14. A program recording scheduling system comprising:
a program guide server which serves a television program guide to the internet;
and multiple program identifying servers which deliver identifying messages to the internet wherein each one of said program identifying servers is adapted to serve identifying messages relevant to only a particular geographical region.

15. A program controller comprising computing means adapted to receive realtime control signals from a remote server using an internet protocol and, according to user input to said computing means, control display, audition or recording of programs.

16. A program controller according to claim 15 further comprising means for receiving a web page representing a television schedule from a remote host, and in which said user input comprises selection of a program item within said web page.

17. A program controller comprising computing means adapted to receive realtime control signals from a remote server using an internet protocol and control means adapted to control program recording means so that recording is suspended while the realtime control signals indicate that non-program material is being broadcast on a channel from which a program is being recorded.

18. A program controller comprising computing means adapted to receive realtime control signals from a remote server using an internet protocol and control means adapted to control program recording means so that recording is suspended while the realtime control signals indicate that a program being broadcast on a channel from which a program is being recorded is of a rating selected for exclusion.

19. A program recording control method comprising the steps of serving a television guide web page to the internet in response to requests from a remote site; transmitting signals identifying which programs are currently or imminently being broadcast; receiving said web page and said identifying signals; receiving user input selecting which program items described in the guide web page correspond to programs to be recorded; comparing the selected program items with the identifying signals and, according to the result of said comparison, controlling operation of recording means.

20. A program recording control method according to claim 19 in which the step of controlling operation of recording means includes the steps of starting recording if the comparison indicates that broadcast of a selected program item is beginning or in progress and stopping recording if the comparison indicates that broadcast of a selected program item is finished.

21. A program recording control method according to claim 19 in which the step of controlling operation of recording or reproduction means includes the step of suspending recording while the identifying signals indicate that non-program material is being broadcast on a channel from which a program is being recorded.

22. A program recording control method according to claim 19-21 and further including the step of tuning a program receiver to a channel according to channel information associated with a program item selected for recording.

23. A program controller comprising;
Computing means adapted to receive television guide information from the internet;
means for constructing a television guide display utilising said television guide information;
means for receiving signals identifying which programs are currently or imminently being broadcast;
means for receiving user input selecting which program items described in said television guide display correspond to programs to be recorded or displayed; and
operation control means adapted to compare the selected program items with said identifying signals and, according to the result of said comparison, control operation of recording or display means.

24. A program controller comprising;
Computing means adapted to receive television guide information from the internet;
means for constructing a television guide display utilising said television guide information;
means for receiving signals identifying which programs are currently or imminently being broadcast;
means for receiving user input selecting which program items described in said television guide display correspond to programs to be recorded; and
means adapted to suspend recording of a program while said identifying signals indicate that non-program material is being broadcast on a channel being recorded.

25. A program controller comprising;
Computing means adapted to receive television guide information from the internet;
means for constructing a television guide display utilising said television guide information;
means for receiving signals identifying which programs are currently or imminently being broadcast;
means for receiving user input selecting which program items described in said television guide display correspond to programs to be recorded; and
means adapted to start recording when said received identifying signals indicate that broadcast of a selected program item is beginning or in progress and stopping recording if the comparison indicates that broadcast of a selected program item is finished

26. A program controller comprising;
Computing means adapted to receive television guide information from the internet;
means for constructing a television guide display utilising said television guide information;
means for receiving signals identifying which programs are currently or imminently being broadcast;
means for receiving user input selecting which program items described in said television guide display correspond to programs to be viewed; and
means adapted to suspend viewing of a program while said identifying signals indicate that non-program material is being broadcast on a channel being viewed.

27. A program controller comprising;
Computing means adapted to receive television guide information from the internet;
means for constructing a television guide display utilising said television guide information;
means for receiving signals identifying which programs are currently or imminently being broadcast; and
means adapted to attenuate the sound level of a program being viewed while said identifying signals indicate that non-program material is being broadcast on the channel being viewed.

28. A program controller comprising;
Computing means adapted to receive television guide information from the internet;
means for constructing a television guide display utilising said television guide information;
means for receiving signals identifying which programs are currently or imminently being broadcast;
means for receiving user input selecting which program items described in said television guide display correspond to programs to be recorded; and
means adapted to suspend recording or viewing of a program while said identifying signals indicate that the classification of material being broadcast on a channel being recorded or viewed is of a classification selected for exclusion.

29. A program controller according to claims 23-28 in which said means for receiving signals identifying which programs are currently or imminently being broadcast is a radio receiver.

30. A program controller according to claims 23-28 in which said means for receiving signals identifying which programs are currently or imminently being broadcast received signals from an optical or electrical cable.

31. A program controller according to claim 23-28 and further comprising means for tuning a program receiver to a channel according to channel information associated with a program item selected for recording.

32. A video recorder comprising:
video recording means; and
computing means adapted to receive realtime control signals from a remote server using an internet protocol and, according to user input to said computing means, control display, audition or recording of programs.

33. A video recorder according to claim 32 further comprising means for receiving a web page representing a television schedule from a remote host, and in which said user input comprises selection of a program item within said web page.

34. A video recorder comprising:
video recording means;
computing means adapted to receive realtime control signals from a remote server using an internet protocol; and
control means adapted to control program recording means so that recording is suspended while the realtime control signals indicate that non-program material is being broadcast on a channel from which a program is being recorded.

35. A video recorder comprising:
video recording means; and
a controller adapted to receive a television guide web page from the internet;
receive signals identifying which programs are currently or imminently being broadcast; receive user input selecting which program items described in the guide web page correspond to programs to be recorded; compare the selected program items with the identifying signals and, according to the result of said comparison, control operation of said recording means.

36. A video recorder comprising:
video recording means; and
a controller adapted to receive a television guide web page from the internet;
receive signals identifying which programs are currently or imminently being broadcast; receive user input selecting which program items described in the guide web page correspond to programs to be recorded; compare the selected program items with the identifying signals, start recording if the comparison indicates that broadcast of a selected program item is beginning or in progress; and stop recording if the comparison indicates that broadcast of a selected program item is finished.

37. A video recorder according to claim 32-36 further comprising a program receiver and wherein said controller is further adapted to tune said receiver to a channel according to channel information associated with a program item selected for recording.

38. A video recorder according to claims 35-36 in which said signals identifying which programs are currently or imminently being broadcast are radio signals.

39. A video recorder according to claims 35-36 in which said signals identifying which programs are currently or imminently being broadcast are received by optical or electrical cable.

40. A video recorder scheduling system substantially as hereinbefore described, with reference to the accompanying drawings.
